(19) United States
(12) Patent Application Publication
(10) Pub. No.: US 2025/0157214 A1
(43) Pub. Date: May 15, 2025

(54) INFORMATION PROCESSING APPARATUS, DISPLAY CONTROL METHOD, AND STORAGE MEDIUM

(71) Applicant: NEC Corporation, Minato-ku, Tokyo (JP)

(72) Inventors: Yuko OHTA, Tokyo (JP); Akihiro NAKAMURA, Tokyo (JP); Takeshi NAGATO, Tokyo (JP); Yukiko TABUCHI, Tokyo (JP); Koki KITAGUCHI, Tokyo (JP)

(73) Assignee: NEC Corporation, Minato-ku, Tokyo (JP)

(21) Appl. No.: 18/839,469

(22) PCT Filed: Mar. 29, 2022
(86) PCT No.: PCT/JP2022/015673

§ 371 Date: Aug. 19, 2024

(51) Int. Cl. G06V 20/20; G06T 11/00; G06V 20/68

(52) U.S. Cl. CPC G06V 20/20; G06T 11/00; G06V 20/68

(57) ABSTRACT

In order for user satisfaction to be increased, an information processing apparatus (1) includes: a determining section (11) for determining content to be overlaid and displayed on an image captured of at least part of a sight of a user, the image having food shown therein; and a display control section (12) for overlaying and displaying the content on the image.

### TECHNICAL FIELD

The present invention relates to augmented reality (AR) technology for overlaying and displaying information on the image captured of at least part of the sight of a user.

### BACKGROUND ART

The use of AR technology for various purposes is under study. For example, Patent Literature 1 below discloses a head mounted display (HMD) utilizing AR technology to manage calorific intake. The HMD of Patent Literature 1 displays a blue filter such that the blue filter is superimposed on food in a case where an allowable calorific intake of a user wearing the HMD is smaller than or equal to a specific value. With the HMD of Patent Literature 1, such processing reduces the user's appetite in a case where the allowable calorific intake is smaller than or equal to the specific value, to control the calorific intake of the user.

### CITATION LIST

### Patent Literature

### Patent Literature 1

Japanese Patent Application Publication Tokukai No. 2020-042401

### SUMMARY OF INVENTION

### Technical Problem

The technique disclosed in Patent Literature 1 is susceptible to improvement in terms of increasing user satisfaction. An example aspect of the present invention has been made in view of this point, and an example object thereof is to provide an information processing apparatus, etc. which are capable of increasing user satisfaction in AR technology targeted for food.

### Solution to Problem

An information processing apparatus in accordance with an example aspect of the present invention includes: a determining means for determining content to be overlaid and displayed on an image captured of at least part of a sight of a user, the image having food shown therein; and a display control means for overlaying and displaying the content on the image.

A display control method in accordance with an example aspect of the present invention includes: at least one processor determining content to be overlaid and displayed on an image captured of at least part of a sight of a user, the image having food shown therein; and the at least one processor overlaying and displaying the content on the image.

A display control program in accordance with an example aspect of the present invention causes a computer to function as a determining means for determining content to be overlaid and displayed on an image captured of at least part of a sight of a user, the image having food shown therein; and a display control means for overlaying and displaying the content on the image.

### Advantageous Effects of Invention

An example aspect of the present invention makes it possible to increase user satisfaction.

### BRIEF DESCRIPTION OF DRAWINGS

FIG. 1 is a block diagram illustrating an information processing apparatus in accordance with a first example embodiment of the present invention.

FIG. 2 is a flowchart illustrating a flow of a display control method in accordance with the first example embodiment of the present invention.

FIG. 3 is a representation of a usage example of an information processing apparatus in accordance with a second example embodiment of the present invention.

FIG. 4 is a block diagram illustrating an example of a configuration of main compositions of the information processing apparatus.

FIG. 5 is a representation of examples of the overlay display of content for changing an apparent volume of food.

FIG. 6 is a representation of an example in which overlaid display is performed with overlay regions being set to regions which show some ingredients.

FIG. 7 is a representation of examples of the overlay display of information regarding food and any other information.

FIG. 8 is a representation of examples of the overlay display of background images in accordance with seasons.

FIG. 9 is a representation of examples of overlay display performed during a meal.

FIG. 10 is a representation of examples of overlay display performed after a meal.

FIG. 11 is a flowchart illustrating a flow of a display control method in accordance with the second example embodiment of the present invention.

FIG. 12 is a flowchart illustrating a flow of a display control method carried out after the start of a meal.

FIG. 13 is a diagram illustrating an example computer which executes the instructions of a program which is software implementing the functions of each of the apparatuses in accordance with the respective example embodiments of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### (Configuration of Information Processing Apparatus 1)

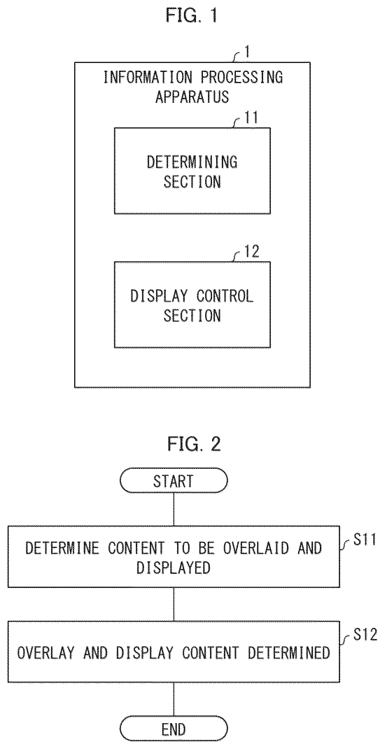

A configuration of an information processing apparatus 1 in accordance with the present example embodiment will be described below with reference to FIG. 1. FIG. 1 is a block diagram illustrating a configuration of the information processing apparatus 1. The information processing apparatus 1 includes a determining section (determining means) 11 and a display control section (display control means) 12, as illustrated in FIG. 1.

The determining section 11 determines content to be overlaid and displayed on an image captured of at least part of a sight of a user, the image having food shown therein.

The display control section 12 overlays and displays, on the image having food shown therein, the content determined by the determining section 11.

As above, a configuration adopted in the information processing apparatus 1 in accordance with the present example embodiment is the configuration in which a determining section 11 and a display control section 12 are included, the determining section 11 determining content to be overlaid and displayed on an image captured of at least part of a sight of a user, the image having food shown therein, the display control section 12 overlaying and displaying, on the image, the content determined by the determining section 11. The information processing apparatus 1 in accordance with the present example embodiment therefore provides an example advantage of making it possible to increase user satisfaction.

### (Display Control Program)

The above functions of the information processing apparatus 1 can be implemented via a program. The display control program in accordance with the present example embodiment causes a computer to function as the determining section 11 and the display control section 12. This display control program provides an example advantage of making it possible to increase user satisfaction.

### (Flow of Display Control Method)

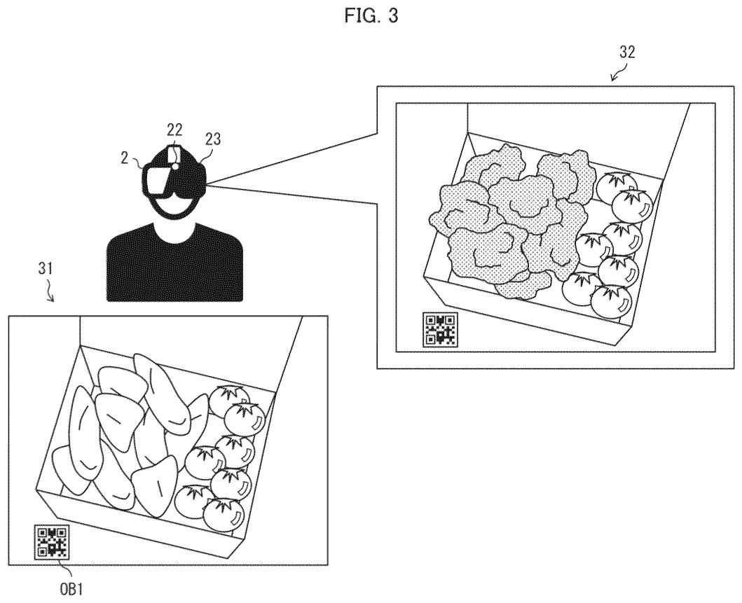

A flow of a display control method in accordance with the present example embodiment will be described below with reference to FIG. 2. FIG. 2 is a flowchart illustrating a flow of the display control method. Each of the steps of this display control method may be carried out by a processor included in the information processing apparatus 1, or may be carried out by a processor included in another apparatus. Alternatively, the steps may be carried out by respective processors provided in different apparatuses.

In S11, at least one processor determines content to be overlaid and displayed on an image captured of at least part of the sight of a user, the image having food shown therein.

In S12, the at least one processor overlays and displays, on the image, the content determined in S11.

As above, the display control method in accordance with the present example embodiment includes: at least one processor determining content to be overlaid and displayed on an image captured of at least part of a sight of a user, the image having food shown therein; and the at least one processor overlaying and displaying, on the image, the content determined. This display control method provides an example advantage of making it possible to increase user satisfaction.

### Second Example Embodiment

### (Outline)

The outline of an information processing apparatus 2 in accordance with the present example embodiment will be described below on the basis of FIG. 3. FIG. 3 is a diagram illustrating a usage example of the information processing apparatus 2. As illustrated, the information processing apparatus 2 is a head mounted display worn on the head of a user while in use. The information processing apparatus 2 is capable of displaying a so-called augmented reality (AR) content.

Thus, the information processing apparatus 2 includes: a capturing section 22 for capturing an image of at least part of the sight of a user wearing the information processing apparatus 2; and a displaying section 23 for displaying the image captured by the capturing section 22. The information processing apparatus 2 overlays and displays AR content on the image captured by the capturing section 22, and allows the user to experience an augmented reality, accordingly.

In displaying AR content, the information processing apparatus 2 detects a predetermined detection target in an image 31 captured of at least part of the sight of the user, the image 31 having food shown therein. In the example of FIG. 3, the information processing apparatus 2 detects a three-dimensional code OB1 attached to a table having a lunchbox placed thereon. Note that the above “food” may be anything that a user can take in. For example, food (such as fruit) made of a single ingredient, cuisine prepared with use of a plurality of ingredients, supplements, medicines, and drink are within the scope of the “food”.

The information processing apparatus 2 then sets an overlay region in the image captured by the capturing section 22 with the detected three-dimensional code OB1 used as a reference, and overlays and displays, on the set overlay region, information regarding food. An image 32 illustrated in FIG. 3 is an image having an image of deep-fried chicken overlaid and displayed on the overlay region which is set to a region showing chicken breast (steamed chicken) in the image 31.

This causes the low-calorie chicken breast to look, to the user wearing the information processing apparatus 2, like deep-fried chicken containing higher calories. This enables the user to feel satisfaction as if the user had eaten deep-fried chicken while cutting calorific intake by actually eating chicken breast. Further, the information processing apparatus 2, which sets the overlay region with the detected three-dimensional code OB1 used as a reference, is capable of overlaying and displaying information (the image of deep-fried chicken in the examples of FIG. 3) regarding food in a proper position.

The information processing apparatus 2 is not limited to a head mounted display, but may be, for example, a smartphone or the like. In a case where a smartphone is used as the information processing apparatus 2, a fixing tool for fixing the display of the smartphone in front of the user's eyes may be used. For example, an eyeglasses-type or goggle-type display or the like can be used as the information processing apparatus 2.

One of the main features of the information processing apparatus 2 in accordance with the present example embodiment is to appropriately determine content to be overlaid and displayed. This will be described below in detail. Any method can be used for setting the overlay region. The overlay region setting is not limited to the above example, in which the three-dimensional code OB1 is used as a reference.

### (Configuration of Information Processing Apparatus 2)

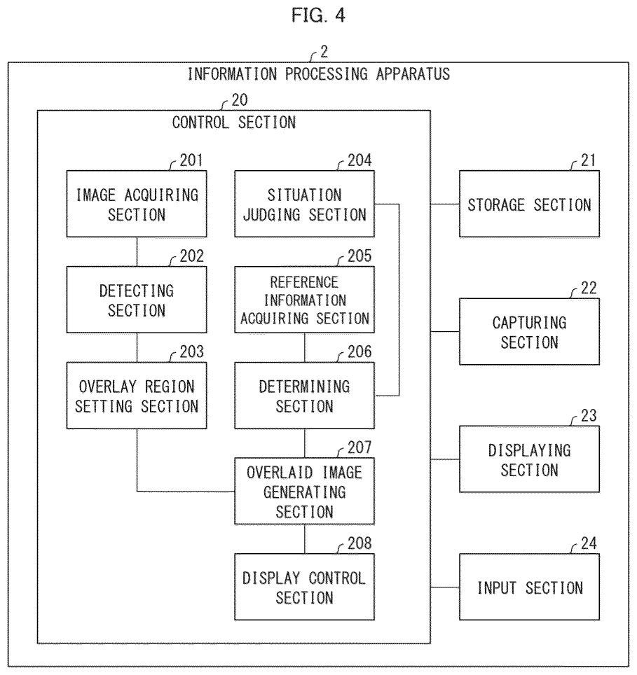

A configuration of the information processing apparatus 2 will be described below on the basis of FIG. 4. FIG. 4 is a block diagram illustrating a configuration of the information processing apparatus 2. The information processing apparatus 2 includes: a control section 20 for performing overall control of the sections of the information processing apparatus 2; and a storage section 21 for storing various kinds of data used by the information processing apparatus 2, as illustrated.

The information processing apparatus 2 further includes: a capturing section 22 for capturing an image; a displaying section 23 for displaying an image; and an input section 24 for accepting an input operation performed on the information processing apparatus 2. The information processing apparatus 2 may be an apparatus which, for example, detects the line of sight of a user and receives the direction and movement of the line of sight as inputs to operate. In this case, the input section 24 can be omitted. In the following description, the direction and movement of the line of sight of the user are referred to as line-of-sight information. As a method for generating the line-of-sight information, a known approach can be used.

The control section 20 includes: an image acquiring section 201; a detecting section 202; an overlay region setting section 203; a situation judging section (situation judging means) 204; a reference information acquiring section (reference information acquiring means) 205; a determining section (determining means) 206; an overlaid image generating section 207, and a display control section (display control means) 208.

The image acquiring section 201 acquires an image captured of at least part of the sight of the user. Since the capturing section 22 is disposed such that the direction of capture is the direction of the line of sight of the user wearing the information processing apparatus 2, an image captured by the capturing section 22 is an image captured of at least part of the sight of the user. The image acquiring section 201 therefore acquires an image captured by the capturing section 22. For example, the image acquiring section 201 may acquire an image by extracting time-series frame images from a moving image captured by the capturing section 22.

The detecting section 202 detects a predetermined detection target in the image acquired by the image acquiring section 201. The predetermined detection target serves as a reference in setting, in an image acquired by the image acquiring section 201, the overlay region of information related to the food shown in the image. For example, in the example of FIG. 3, the three-dimensional code OB1 is the predetermined detection target. As a matter of course, the predetermined detection target only needs to serve as a reference in setting the overlay region, and is not limited to the three-dimensional code OB1.

The overlay region setting section 203 uses, as the reference, the above detection target detected by the detecting section 202, to set the content overlay region in the image acquired by the image acquiring section 201. As described above, a method for setting the overlay region is any method. For example, the overlay region setting section 203 may set the overlay region to a region identified with use of a detection model having learned the appearance of a target (e.g. specific food) on which to overlay content. In this case, the detecting section 202 may be omitted.

The situation judging section 204 judges the meal situation of the user. The meal situation judged by the situation judging section 204 only needs to be a situation regarding a user's meal. For example, the situation judging section 204 may judge at least one of the group consisting of a degree (hereinafter referred to as degree of concentration) to which the user concentrates on eating the meal, the degree of progress of meal (including whether the user has finished eating the meal), the pace of eating a meal (which can said to be a speed at which meal is eaten), the amount of leftovers, and the presence or absence of leftovers.

The reference information acquiring section 205 acquires reference information to be referred to by the determining section 206 during the determination of the content. The reference information only needs to be information which contributes to the determination of suitable content. For example, the reference information may be user-related information regarding a user, may be information indicating the situations of the current season, weather, etc., or may be information regarding food served to a user.

The determining section 206 determines content to be overlaid and displayed on an image acquired by the image acquiring section 201, i.e. the image captured of at least part of the sight of the user. In particular, the determining section 206 determines content to be overlaid and displayed on an image having food shown therein. Further, the determining section 206 determines that content in accordance with the reference information acquired by the reference information acquiring section 205 is the content to be overlaid and displayed. Furthermore, in a case where the situation judging section 204 judges a meal situation, the determining section 206 determines content in accordance with the meal situation.

The content only needs to be displayable content. The content may be an image, may consist of characters, or may be a combination of an image and a character. Further, the above image may be a moving image, or may be a still image.

The overlaid image generating section 207 generates an overlaid image to be overlaid on the image acquired by the image acquiring section 201. More specifically, the overlaid image generating section 207 uses a source image (e.g. texture images of various kinds of food, templates for displaying various kinds of information, and the image of a character (described later)) of the overlaid image, the source image corresponding to the content determined by the determining section 206, to generate the overlaid image. The source image of the overlaid image may be stored in the storage section 21 or the like.

The display control section 208 overlays and displays, on the image acquired by the image acquiring section 201, the content determined by the determining section 206. Specifically, the display control section 208 overlays and displays the content, by displaying the overlaid image generated by the overlaid image generating section 207 such that the overlaid image is combined with the overlay region set by the overlay region setting section 203.

The display control section 208 may switch to turn the overlay display on and off according to the situation. For example, the display control section 208 may judge, on the basis of the line-of-sight information, whether the user is watching food (or some ingredients of the food), and in a case of judgment that the user is not watching the food, turn off the overlay display performed on the food (or some ingredients of the food).

As above, a configuration adopted in the information processing apparatus 2 in accordance with the present example embodiment is the configuration in which a determining section 206 and a display control section 208 are included, the determining section 206 determining content to be overlaid and displayed on an image captured of at least part of a sight of a user, the image having food shown therein, the display control section 208 overlaying and displaying the content determined by the determining section 206 on the image. The information processing apparatus 2 in accordance with the present example embodiment therefore provides an example advantage of making it possible to increase user satisfaction. Note that the “image captured of at least part of a sight of a user” may be an image captured on the basis of the result of detection of the line of sight or sight of a user, or may be an image of surroundings of the user captured without such detection.

As described above, the information processing apparatus 2 includes the situation judging section 204 for judging a meal situation of the user, and the determining section 206 determines that content in accordance with a meal situation judged by the situation judging section 204 is the content to be overlaid and displayed. This provides an example advantage of making it possible to increase user satisfaction by overlaying and displaying content in accordance with a meal situation, in addition to the example advantage provided by the information processing apparatus 1 in accordance with the first example embodiment.

The determining section 206 may use a content prediction model having undergone machine learning of a relationship between a meal situation and content to be displayed in the meal situation, to determine content in accordance with the meal situation judged by the situation judging section 204. This provides an example advantage of making it possible to overlaid and display content which is based on the result of machine learning and is therefore highly valid, to increase user satisfaction, in addition to the example advantage provided by the information processing apparatus 1 in accordance with the first example embodiment. Note that the above content prediction model can be generated by machine learning of a relationship between an explanatory variable and a response variable, given that a meal situation is the explanatory variable and content to be displayed in the meal situation is the response variable.

As described above, the information processing apparatus 2 includes the reference information acquiring section 205 for acquiring reference information to be referred to during the determination of the content, and the determining section 206 determines that content in accordance with the reference information acquired by the reference information acquiring section 205 is the content to be overlaid and displayed. This provides an example advantage of making it possible to overlay and display highly valid content in accordance with the reference information, to increase user satisfaction, in addition to the example advantage provided by the information processing apparatus 1 in accordance with the first example embodiment.

Also in this case, the determining section 206 may use the content prediction model having undergone machine learning of a relationship between the reference information and content to be displayed when the reference information is acquired (a content prediction model having undergone machine learning of a relationship between an explanatory variable and a response variable, given that the reference information is an explanatory variable and content to be displayed when the reference information is acquired is a response variable), to determine content in accordance with the reference information acquired by the reference information acquiring section 205.

### Example Overlay Display 1: Change Apparent Volume

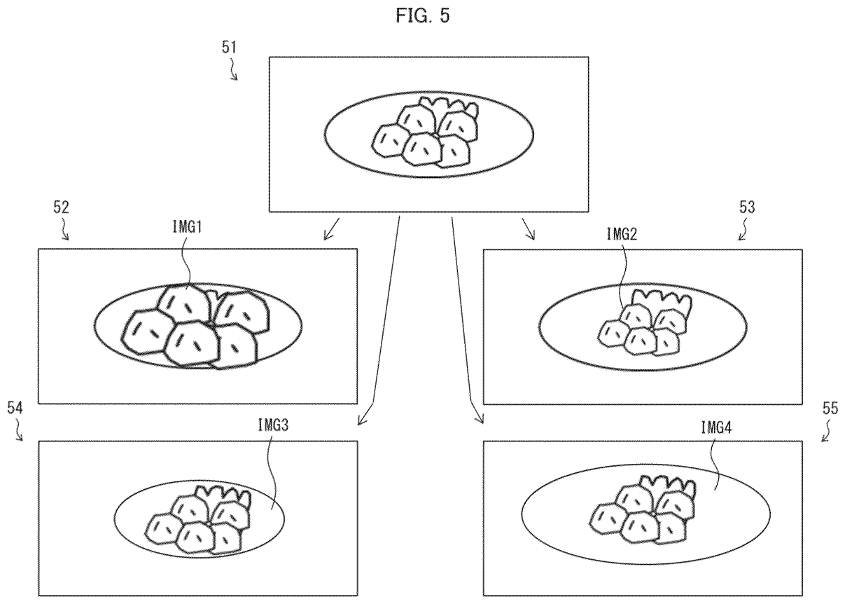

The determining section 206 may determine that content for changing an apparent volume of food is the content to be overlaid and displayed. This will be described below with reference to FIG. 5. FIG. 5 is a representation of examples in which content for changing an apparent volume of food is overlaid and displayed. In FIG. 5, an image 51 is an image captured by the capturing section 22 and acquired by the image acquiring section 201, i.e. an image captured of at least part of the sight of a user. In the image 51, cuisine (food) arranged on a dish is shown.

Depending on the user, increasing an apparent volume of food can improve satisfaction of the user with the meal. For example, in a case of a user on a diet, increasing an apparent volume causes the user to have the feeling of having eaten a lot, despite an actual reduction in the amount of meal. This can improve the satisfaction of the user with the meal. Meanwhile, in a case of a user who is a small eater, reducing an apparent volume enables the user to take in a required amount of meal. This can improve the satisfaction of the user with the meal.

In a case of increasing an apparent volume of food, the determining section 206 may determine, for example, that an image of food which is the same as actual food present in front of the user except that the volume thereof is greater than the actual food is the content to be overlaid on the image 51. An image 52 of FIG. 5 is an image obtained by overlaying, on the image 51, the image of food the volume of which is greater. Such content may be prepared in advance, or may be generated by using the image 51 as a source image. Although the food shown in the image 52 is obtained by scaling up the food shown in the image 51, an image showing an increased number of pieces of food may be the content to be overlaid and displayed.

Further, in a case of increasing an apparent volume of food, the determining section 206 may determine, for example, that an image of a dish having a smaller size than the dish shown in the image 51 is the content to be overlaid and displayed. An image 54 of FIG. 5 is an image obtained by overlaying, on the dish which is shown in the image 51 and on which the food is arranged, an image of a dish having a somewhat smaller size. In this manner, also by overlaying, on the dish shown in the image 51 and holding food, an image of a dish having a smaller size, it is possible to cause the amount of food to look greater. Note that, in a case where food is contained in a container, an image of a container having a smaller size may be overlaid and displayed.

Meanwhile, in a case of reducing an apparent volume of food, the determining section 206 may determine, for example, that an image of food which is the same as actual food present in front of the user except that the volume thereof is smaller than the actual food is the content to be overlaid on the image 51. An image 53 of FIG. 5 is an image obtained by overlaying, on the image 51, the image of food the volume of which is smaller. Such content may be prepared in advance, or may be generated by using the image 51 as a source image. Although the food shown in the image 52 is obtained by scaling down the food shown in the image 51, an image showing a reduced number of pieces of food may be used.

In a case of reducing an apparent volume of food, the determining section 206 may determine, for example, that an image of a dish having a larger size than the dish shown in the image 51 is the content to be overlaid and displayed. An image 55 of FIG. 5 is an image obtained by overlaying, on the dish which is shown in the image 51 and on which the food is arranged, an image of a dish having a somewhat larger size. In this manner, also by overlaying, on the dish which is shown in the image 51 and on which the food is placed, an image of a dish having a larger size, it is possible to cause the amount of food to look smaller. Note that, in a case where food is contained in a container, an image of a container having a larger size may be overlaid and displayed.

As above, the determining section 206 may determine that an image of predetermined food is the content to be overlaid and displayed, and the display control section 208 may overlay and display, on the food shown in an image, captured by the capturing section 22, of at least part of the sight of a user, the predetermined food determined by the determining section 206. This provides an example advantage of making it possible to change the appearance of food to increase user satisfaction, in addition to the example advantage provided by the information processing apparatus 1 in accordance with the first example embodiment.

The predetermined food above may be the same as the food shown in the image captured by the capturing section 22 except for an amount. This provides an example advantage of making it possible to give a user an illusion about the amount of food, in addition to the example advantage provided by the information processing apparatus 1 in accordance with the first example embodiment.

As a matter of course, the determining section 206 may determine that an image of food different from the food shown in the image captured by the capturing section 22 is the content to be overlaid and displayed on the food shown in the image captured by the capturing section 22, as in the example of FIG. 3.

For example, in a case where the reference information acquired by the reference information acquiring section 205 indicates that the user wishes to cut calorific intake, the determining section 206 may determine that an image of food containing higher calories than the food shown in the image, captured by the capturing section 22, of at least part of the sight of the user is the content to be overlaid and displayed. The display control section 208 may then overlay and display, on the food shown in the image captured of at least part of the sight of the user, the image determined by the determining section 206. This provides an example advantage of making it possible to give a user an illusion that the user is eating high-calorie food to increase the satisfaction with a meal, while realizing a user's wish to cut calorific intake, in addition to the example advantage provided by the information processing apparatus 1 in accordance with the first example embodiment.

The image of food containing higher calories than the food shown in the image captured by the capturing section 22 may be the image of food the ingredients of which are the same or similar but the cooking method of which is different and which therefore contains higher calories, as in the example of FIG. 3, or may be the image of food the volume of which is greater and which therefore contains higher calories, as in the example of the image 52 of FIG. 5.

Whether to wish to cut calorific intake may be selected by a user. The selection may be made by an input operation performed via the input section 24, or may be made through line-of-sight information. For example, the display control section 208 may display the message “Are you on a diet?” and choices of “YES” and “NO” on the displaying section 23. In a case where the line of sight of the user stays on the choice of “YES” for not shorter than a predetermined amount of time, the reference information acquiring section 205 may then judge that the user is a user who wishes to cut calorific intake. Reference information other than the reference information on whether to wish to cut calorific intake can be inputted in the same manner. Note that user attributes (characteristics possessed by a user) inferred by the appearance of the user, such as the age or age group and the gender of the user, may be identified by, for example, analyzing the image of the user.

The criterion of determination of food the image of which is the content to be overlaid and displayed is not particularly limited. As an example, the determining section 206 may determine that an image of food close in eating texture and shape to the food shown in the image captured by the capturing section 22 is the content to be overlaid and displayed. As another example, setting information which specifies food on which overlay display is performed and an image to be overlaid and displayed on the food may be registered by a user in advance with the information processing apparatus 1. In this case, the overlay region setting section 203 sets the overlay region in accordance with the setting information, and the determining section 206 determines the content in accordance with the setting information.

As still another example, the determining section 206 may determine the content with use of a prediction model constructed by machine learning. In constructing this prediction model, the machine learning of the relationship between an explanatory variables and a response variable may be performed, by taking, as the explanatory variables, various kinds of information to be taken into consideration to select valid content to be overlaid and displayed, the various kinds of information including user attributes and the food shown in the image captured by the capturing section 22, and taking, as the response variable, content to be overlaid and displayed. Note that the configuration of determining the content with use of a prediction model is not limited to the case in which the image of food is overlaid and displayed, but can be used at the time of determination of any content.

As still another example, the determining section 206 may select a plurality of candidates for content to be overlaid and displayed, to display these candidates via the display control section 208. The determining section 206 may then determine that the content selected by a user is the content to be overlaid and displayed. Also regarding the configuration of causing a user to make the selection, such a configuration is not limited to the case in which the image of food is overlaid and displayed, but can be used at the time of determination of any content.

As above, the determining section 206 may determine that the image of a container or a dish which is different in size from the container or the dish which holds the food is the content to be overlaid and displayed. In this case, the display control section 208 overlays and displays, on the background of the food shown in the image, captured by the capturing section 22, of at least part of the sight of a user, the image of the container or the dish determined by the determining section 206. This provides an example advantage of making it possible to give an illusion about the volume of food to increase user satisfaction, in addition to the example advantage provided by the information processing apparatus 1 in accordance with the first example embodiment.

### Example Overlay Display 2: Change Appearance of Some Ingredients

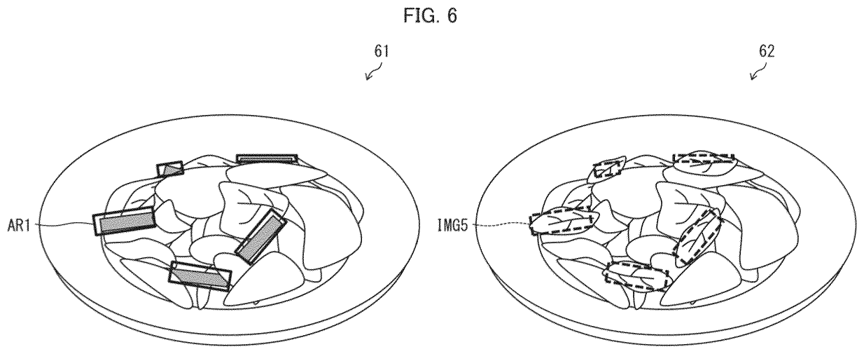

The overlay region setting section 203 may set the overlay region in the image captured by the capturing section 22 to a region showing some ingredients of the food shown in the image. This will be described below on the basis of FIG. 6. FIG. 6 is a representation of an example in which overlaid display is performed with the overlay regions being set to regions which show some ingredients.

Illustrated in FIG. 6 are an image captured by the capturing section 22, i.e. an image 61 captured of at least part of the sight of a user wearing the information processing apparatus 2 and an image 62 obtained by overlaying and displaying the image of another food on each of the overlay regions set in the image 61.

In the image 61, cuisine arranged on a dish is shown, and the overlay region set in each of the regions showing some ingredients contained in this cuisine is indicated by AR1. A method for setting the overlay region AR1 is not particularly limited, but the overlay region setting section 203 may set the overlay region AR1 to, for example, a rectangular region which contains a region consisting of pixels of a predetermined color range corresponding to a target ingredient. For example, in a case where the target ingredient is a carrot, the overlay region setting section 203 may set the overlay region AR1 to a region consisting of orange pixels. As a matter of course, a method for identifying a region showing food is any method. For example, in a case of an ingredient having a distinctive shape, a region showing the ingredient may be identified by an image analysis based on the shape, or the region showing the ingredient may be identified with use of a detection model having learned the appearances of ingredients.

The overlaid image generating section 207 then uses the image of another ingredient to generate an overlaid image to be overlaid on the overlay region AR1, and the display control section 208 overlays and displays this overlaid image on the overlay region AR1. This causes the user wearing the information processing apparatus 2 to recognize that the ingredient in the overlay region AR1 is another ingredient, as indicated in the image 62. Such a display enables a user to eat an ingredient which the user avoids eating and thus dislikes, or makes it possible to increase satisfaction with cuisine by making the cuisine look as if the cuisine contained an ingredient the user likes. Note that it is possible to identify the preference of a user with use of the reference information acquired by the reference information acquiring section 205.

Specifically, in a case where the reference information acquired by the reference information acquiring section 205 indicates the preference of the user, the determining section 206 may determine that the image of food which matches the preference indicated by the reference information is the content to be overlaid and displayed. For example, in a case where the reference information indicates that the user likes meat, the determining section 206 may determine that an image of meat is the content to be overlaid and displayed. The display control section 208 may then overlay and display, on the food shown in the image, captured by the capturing section 22, of at least part of the sight of the user, the image determined by the determining section 206. This provides an example advantage of making it possible to give a user an illusion that the food in front of the user is food which matches the preference of the user, to increase user satisfaction, in addition to the example advantage provided by the information processing apparatus 1 in accordance with the first example embodiment.

As described above, the overlay region setting section 203 may set the overlay region to a region showing an ingredient which does not match the preference of a user. The determining section 206 may then determine that an image of an ingredient which matches the preference of the user (or an ingredient the mismatch of which with the preference of the user has at least not been proved) is the content to be overlaid and displayed. This provide an example advantage of making it possible to give a user an illusion that an ingredient that does not match the preference of the user is not contained, to assist the user in overcoming the practice of avoiding eating and thus disliking the ingredient, or any other practice.

The determining section 206 may determine that content for changing the color of at least one ingredient contained in food shown in the image captured by the capturing section 22 to the color of another ingredient is the content to be overlaid and displayed. For example, in a case where the overlay region setting section 203 sets the overlay region AR1 to a region consisting of orange pixels in sauteed vegetables, the determining section 206 may determine that a green filter is the content to be overlaid and displayed on this overlay region AR1. This makes it possible to make the sauteed vegetables look as if the sauteed vegetables did not contain a carrot, without changing the outline of the sauteed vegetables.

### Example Overlay Display 3: Display of Information Regarding Food and any Other Information

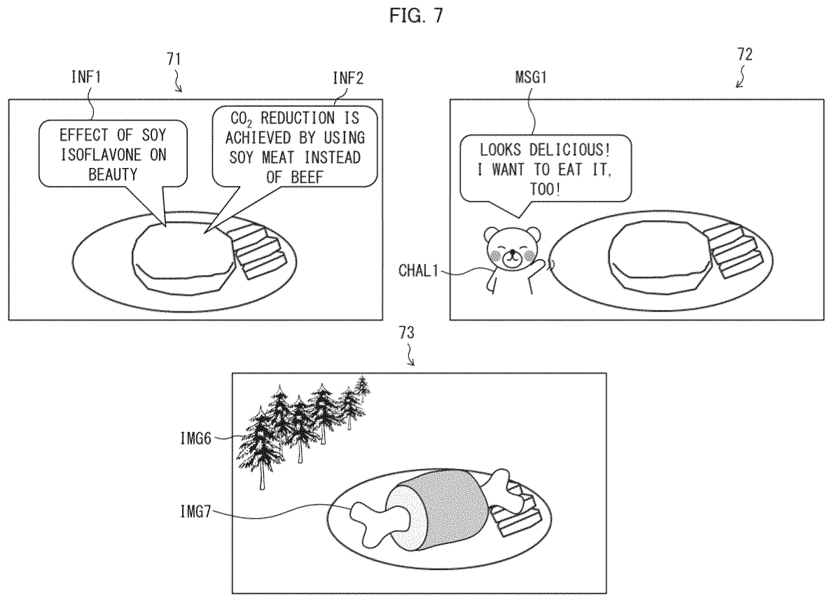

The determining section 206 may determine that information regarding food is the content to be overlaid and displayed. Further, the determining section 206 may determine that an image of a person or a character is the content to be overlaid and displayed. Furthermore, the determining section 206 may determine that a picture of food is the content to be overlaid and displayed. These will be described below on the basis of FIG. 7. FIG. 7 is a representation of examples in which information regarding food and any other information are overlaid and displayed.

### (Overlay Display of Information Regarding Food)

Illustrated in FIG. 7 are images 71 to 73 in each of which content is overlaid and displayed. Among these images, the image 71 represents an example in which information regarding food is overlaid and displayed. Specifically, in the image 71, information INF1 and information INF2 are overlaid and displayed in the form of a speech balloon associated with cuisine (food) arranged in a dish. The information INF1 indicates a component contained in the cuisine with which the information is associated and a function of the component. The information INF2 indicates an ingredient of the cuisine with which the information is associated and a social significance of using the ingredient. By overlaying and displaying information regarding food in this manner, it is possible to deepen user's understanding of the food, to increase satisfaction with eating the food. It is also possible to provide the user with knowledge about the food.

Such information may be determined according to a user attribute. For example, in a case where the user is a child, the determining section 206 may determine that content useful in food and nutritional education is the content to be overlaid and displayed. The content useful in food and nutritional education only needs to enable a user to obtain knowledge about food, and may be, for example, content which contains information such as an ingredient used, the production region of the ingredient, the producer, and the production region.

A timing at which the information regarding food is overlaid and displayed is not particularly limited, but, for example, the display control section 208 may overlay and display the information at a timing at which the food starts to be shown in the image captured by the capturing section 22. Further, when judging, on the basis of line-of-sight information, that a user is watching the food (or some ingredients of the food), the display control section 208 may overlay and display the information regarding the food (or some ingredients of the food). In this case, when judging, on the basis of the line-of-sight information, that the user takes the eyes off the food (or some ingredients of the food), the display control section 208 may end the overlay display of the information.

### (Overlay Display of Image of Character)

An image 72 illustrated in FIG. 7 indicates an example of overlay display of the image of a character. Specifically, on the image 72, a character CHAL1 which is a bear and a message MSG1 from the character CHAL1 are overlaid and displayed on a portion lateral to cuisine (food) arranged on a dish for display. With such an overlay display of the image of a character, it is possible to give a user an illusion that the user is eating a meal together with the character, to increase satisfaction with the meal.

The character to be overlaid and displayed may be a two-dimensional character, or may be a three-dimensional character. Further, a still image of the character may be overlaid and displayed, or an animation (moving image) of the character may be overlaid and displayed. For example, an animation in which the character walks about around the cuisine may be overlaid and displayed. This is effective in a case where, for example, the user is a child. This is because a moving character makes it possible to prevent a child from being bored, to make a child eat a meal.

The overlay display of the character may start in response to a user's operation. As an example, the user's eyes being focused on food or on a predetermined article around the food for a predetermined amount of time may trigger the start of the overlay display of the character. As another example, the user performing a predetermined action such as cutting into food with a knife may trigger the start of the overlay display of the character. For example, the user cutting into the food with a knife may trigger the display of an animation in which the character emerges from the section of the food. This makes it possible to increase user's amusement.

As another example, with a picture of a character disposed close to food, user's eyes being focused on the picture for a predetermined amount of time may trigger the start of the overlay display of a three-dimensional animation of the character drawn in the picture. This makes it possible to smoothly lead a user to a three-dimensional animation world.

A target on which user's eyes are focused is not limited to a real article. For example, the determining section 206 may determine that an object (e.g. the image of a switch or a button, or the picture of a character as described above) for starting the display of a character is the content to be overlaid and displayed, and the display control section 208 may display the object. The determining section 206 may use, as a trigger, user's eyes being focused for a predetermined amount of time on the object overlaid and displayed, to determine that a character corresponding to the object is the content to be overlaid and displayed. Note that the content to be displayed with use of the trigger is not limited to a character, but, for example, information regarding food may be displayed with use of the trigger.

The position at which the character is overlaid and displayed is not particularly limited. For example, the character may be overlaid and displayed on the surrounding area of food, as described above, may be overlaid on food for display, or may be overlaid and displayed on a person around the user. Further, the image of a person may be overlaid and displayed, instead of the character. For example, the determining section 206 may determine that the image of the face of a predetermined person is the content to be overlaid and displayed on a facial region of the person around the user. This makes it possible to give a user meal experience which is as if the user was having a meal together with a predetermined person, to increase satisfaction with the meal. For example, by setting the predetermined person to a celebrity, it is possible to give a user the experience of having a meal together with the celebrity.

In a case where the image of a character or a person is overlaid and displayed, the reference information acquiring section 205 preferably acquires, as the reference information, preference information which indicates the preference of a user regarding the character or the person. This makes it possible for the determining section 206 to determine that the image of a character or a person which matches the preference of the user is the content to be overlaid and displayed.

In this manner, the determining section 206 may determine that the image of a person or a character is the content to be overlaid and displayed. The display control section 208 may then overlays and display, on the image captured of at least part of the sight of the user, the image of the person or the character determined. This provides an example advantage of making it possible to give the experience of having a meal together with a person or a character overlaid and displayed, to make it possible to increase satisfaction with the meal, in addition to the example advantage provided by the information processing apparatus 1 in accordance with the first example embodiment.

### (Overlay Display of Picture of Food)

An image 73 illustrated in FIG. 7 represents an example of the overlay display of a picture of food. Specifically, in the image 73, an IMG7 which is the picture of enormous meat on bones is overlaid and displayed on cuisine (food) arranged on a dish. In this manner, by overlaying and displaying the picture (illustration) of food, it is possible to provide meal experience of eating unreal food, the meal experience being difficult to obtain in real life, to increase satisfaction with the meal. Note that the picture to be overlaid and displayed may be a realistic picture, or may be a cartoon depicting exaggerated food or food which does not exist in real life.

The display control section 208 may produce an effect of increasing user's amusement during overlay display. For example, the display control section 208 may gradually change the food shown in the image captured by the capturing section 22 to food overlaid and displayed. Such display can be provided by, for example, starting the overlay display with a high degree of transparency of the overlaid image and reducing the degree of transparency of the overlaid image over time. Further, the display control section 208 may display an animation in which food overlaid and displayed moves. For example, the display control section 208 may display an animation in which the food overlaid and displayed falls onto and then replace the food shown in the image captured by the capturing section 22.

In a case of overlaying and displaying the picture or image of food, the display control section 208 may update the picture or image of the food overlaid and displayed as a user makes progress in eating food, to link the degree of progress of the meal to the picture or image of the food overlaid and displayed. Further, the display control section 208 may deliberately keep the picture or image of the food overlaid and displayed from being updated, to provide the unrealistic experience of being unable to make a dent in the food although keeping eating.

In the image 73, an image IMG6 of conifers is overlaid and displayed on the background of the food. Such a background image contributes to create a dining atmosphere. Any criterion of determination of the background image can be applied. For example, the determining section 206 may determine a background image in accordance with food. In this case, the reference information acquiring section 205 may identify the food, for example, by analyzing the image captured by the capturing section 22 or with reference to the details of an order made by the user, to acquire the result of the identification as the reference information. This enables the determining section 206 to determine, with reference to the result of the identification indicated in the reference information, a background image in accordance with the food.

As above, in a case where the reference information indicates the result of identification of the food shown in the image, the determining section 206 may determine that a background image in accordance with the result of the identification is the content to be overlaid and displayed. The display control section 208 may then overlay and display, on the background of the food shown in the image captured of at least part of the sight of the user, the background image determined. This provides an example advantage of making it possible to increase user satisfaction by causing the user to have a meal while watching the background image in accordance with food, in addition to the example advantage provided by the information processing apparatus 1 in accordance with the first example embodiment. As another example, it is possible to perform display of an unrealistic background image, the display being, for example, displaying a cherry tree on the table.

The background image may be a still image, or may be a moving image. With a background image which is a moving image, it is possible to display a background image in which, for example, grasses sway in the wind or pedals flutter.

Besides the above, the determining section 206 may determine that content for producing a dining atmosphere which is, for example, content representing the state where food is steaming, content representing the state where food is turning brown, or content representing the state where wind is blowing is the content to be overlaid and displayed.

In a case where the information processing apparatus 2 has the function of outputting voice, the determining section 206 may determine that content containing voice is the content to be presented to a user. This makes it possible to produce an effect which contains voice. Further, in a case where the information processing apparatus 2 includes an olfactory display which emits a gas having a predetermined scent, the determining section 206 may determine that a scent which can be emitted by the olfactory display is the content to be presented to a user. This makes it possible to produce an effect which contains a scent.

### Example Overlay Display 4: Display in Accordance with Season

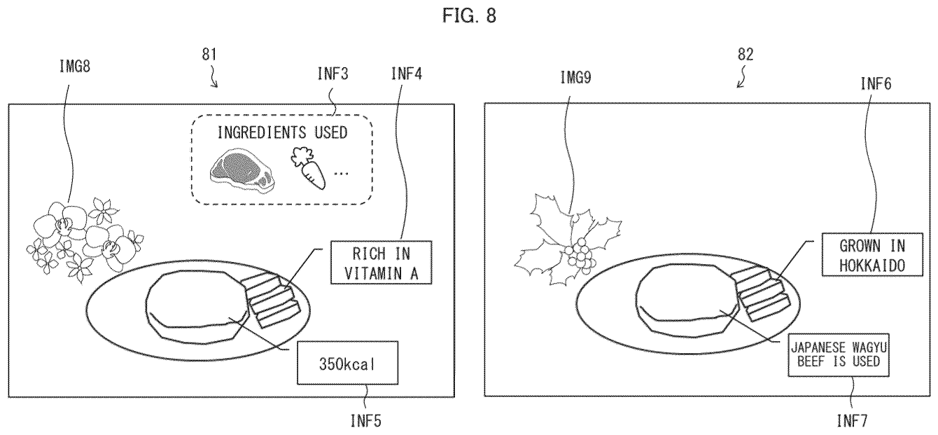

The determining section 206 may determine that a background image in accordance with a season is the content to be overlaid and displayed. This will be described below on the basis of FIG. 8. FIG. 8 is a representation of examples of the overlay display of background images in accordance with seasons. Specifically, in FIG. 8, an image 81 indicates an example in which a background image is overlaid and displayed during the spring season, and an image 82 indicates an example in which a background image is overlaid and displayed during the winter season.

In the image 81, an image IMG8 of spring flowers is displayed as the background image. In the image 82, an image IMG9 of a holly used for Christmas ornament is displayed as the background image. In this manner, even with the same food, it is possible to create a sense of each season by the overlay display of a background image in accordance with the season, and increase user satisfaction accordingly.

Similarly, the determining section 206 may determine that a background image in accordance with the current weather is the content to be overlaid and displayed. In this manner, by determining a background image in accordance with the current condition surrounding a user, such as the current season or weather, it is possible to impart a special feeling to a meal to increase user satisfaction. Note that the current condition is not limited to a season or weather, but may be, for example, the number, the age group, or the gender of people accompanying a user, the mood in which a user is, etc. It is possible to judge the mood in which a user is, by analyzing the facial expression and the action of the user.

In a case of the overlay display of the background image in accordance with the condition surrounding a user, the reference information acquiring section 205 may acquire the reference information which indicates the situation surrounding the user. This enables the determining section 206 to determine that a background image, indicated by the reference information, in accordance with the situation surrounding the user is the content to be overlaid and displayed.

The image 81 and the image 82 illustrated in FIG. 8 also have various kinds of information regarding food overlaid and displayed therein. Specifically, overlaid and displayed in the image 81 are information INF3 indicating the ingredients used in the cuisine, information INF4 regarding the nutrients contained in the cuisine, and information INF5 indicating calories of the cuisine. Overlaid and displayed in the image 82 are information INF6 indicating the production region of an ingredient used in the cuisine and information INF7 regarding an ingredient used in the cuisine.

In this manner, by overlaying and displaying various kinds of information regarding food, it is possible to deepen the knowledge of the food and a degree to which a user is convinced, to increase user satisfaction with eating the food. As a matter of course, the information regarding food is not limited to the example above. For example, information indicating the raw materials, the cook, the producer, the freshness, the price, etc. of food may be overlaid and displayed, or allergy information such as whether an allergic ingredient is contained, or the name of the allergic ingredient may be overlaid and displayed.

In a case where the reference information indicating a season is acquired, the determining section 206 may judge whether an ingredient the best season for which is the season is contained in the ingredients used in cuisine, and when such an ingredient is contained, may determine that information indicating the ingredient is in season is the content to be overlaid and displayed.

### Example Overlay Display 5: Display During Meal

The situation judging section 204 may judge the degree of progress, which is a degree to which the user makes progress on eating a meal, the degree of progress being the meal situation of the user. In this case, the determining section 206 may determine that content in accordance with the degree of progress judged is the content to be overlaid and displayed. This provides an example advantage of making it possible to link content to the degree of progress of a meal, in addition to the example advantage provided by the information processing apparatus 1 in accordance with the first example embodiment.

The definition of the degree of progress is any definition. For example, the degree of progress may be expressed in three stages which are: meal not started yet; meal in progress; and meal finished, or may be expressed in two stages which are given by whether a meal is finished. Through, for example, the analysis of the image captured by the capturing section 22, the situation judging section 204 can judge under which of the stages the degree of progress falls.

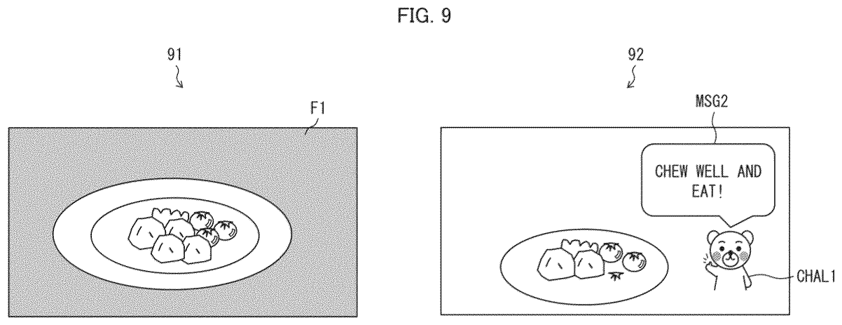

FIG. 9 is a representation of examples of overlay display performed during a meal (to be exact, in a case where the situation judging section 204 makes a judgment of meal in progress). Specifically, in FIG. 9, an image 91 indicates an example of the overlay display of content performed when a user does not concentrate on eating a meal, and an image 92 indicates an example of the overlay display of content performed when a user is eating the meal at a high pace.

In the image 91, a filter F1 is overlaid and displayed on the entire image 91 except the area surrounding the food. This makes anything except the food less conspicuous, and therefore makes it possible to increase the degree of concentration of the user on the meal. The filter F1 preferably has a monochromatic dark tone so that the food and the area surrounding the food are highlighted. Further, the filter F1 may be transparent, or may be opaque.

In a case of the overlay display of content in accordance with the degree of concentration of the user, such as the filter F1, the situation judging section 204 judges the degree of concentration which is a degree to which the user concentrates on eating the meal, in addition to judging that the user is eating the meal. As a matter of course, the judgment that meal is in progress and the judgment of the degree of concentration may be carried out separately in respective processing blocks.

A method for judging the degree of concentration is not particularly limited. As an example, the situation judging section 204 may judge the degree of concentration on the basis of the line-of-sight information regarding a user. In this case, for example, the situation judging section 204 may calculate a proportion, in a predetermined amount of time, of the amount of time during which the line of sight of the user is in the direction of the food, and takes the calculated value as the degree of concentration. As another example, the situation judging section 204 may calculate a proportion, in the predetermined amount of time, of the amount of time during which the line of sight of the user is in the direction of something (e.g. the character overlaid and displayed) other than the food, and takes the reciprocal of the calculated value as the degree of concentration.

As another example, the situation judging section 204 may judge the degree of concentration on the basis of a change in the image captured by the capturing section 22 over time. In this case, for example, the situation judging section 204 may calculate the amount of decrease in the food or the rate of decrease in the food (which can be expressed as the pace of eating a meal) in a predetermined amount of time, and take the calculated value as the degree of concentration. The amount of decrease in food or the rate of decrease in food can be calculated on the basis of, for example, the area of a region showing the food in an image.

As still another example, the situation judging section 204 may judge the degree of concentration of the user with use of a prediction model for predicting the degree of concentration constructed by machine learning. In the construction of this prediction model, by taking, as explanatory variables, various kinds of information related to the degree of concentration of the user, and taking the degree of concentration of the user as a response variable, the machine learning of the relationship between the explanatory variables and the response variable may be performed. Examples of the information related to the degree of concentration include the above-described line-of-sight information and pace of eating a meal.

As above, the situation judging section 204 may judge the degree of concentration which is a degree to which a user concentrates on eating a meal. The determining section 206 may determine that content in accordance with the degree of concentration judged is the content to be overlaid and displayed. This provides an example advantage of making it possible to control the degree of concentration of the user, in addition to the example advantage provided by the information processing apparatus 1 in accordance with the first example embodiment. For example, it is possible to encourage the concentration on eating a meal or perform display which does not interfere with the concentration.

The filter F1 in the image 91 of FIG. 9 is an example of the content for encouraging the concentration on eating a meal. As a matter of course, the content for encouraging the concentration on eating a meal is not limited to this example. As an example, a message for encouraging the concentration on eating may be overlaid and displayed as the content for encouraging the concentration on eating a meal. Further, this message may be overlaid and displayed as a message from a character overlaid and displayed. As another example, the display control section 208 may perform display for encouraging the end of the overlay display or the switching of content to be overlaid and displayed. This is effective in a case where content overlaid and displayed interferes with a user eating a meal.

Examples of the display which does not interfere with the concentration include reducing content to be overlaid and displayed. By the display control section 208 reducing the content to be overlaid and displayed in a case where the degree of concentration judged by the situation judging section 204 is high, it is possible to maintain the state in which the user concentrates on eating a meal. Further, the display control section 208 may increase content to be overlaid and displayed in a case where the degree of concentration is low. This enables the user to enjoy the content during the break in a meal. Note that the “reducing content” may be a reduction in the number of pieces of content to be displayed or in the number of words contained in the content, or may be a reduction in the display area of the content or in the amount of display time of the content. The same applies to the “increasing content”.

On the image 92 illustrated in FIG. 9, the character CHAL1 is overlaid and displayed on a portion lateral to the food, together with a message MSG2 from the character CHAL1. The message MSG2 is for encouraging the user to chew well and eat the meal. The determining section 206 determines that such content is the content to be overlaid and displayed in a case where the user is eating a meal at a high pace, to make it possible to adjust the pace at which the user eats the meal. For example, in a case where a user is eating a meal at a slow pace, the determining section 206 may determine that content which contains a message encouraging a user to increase the eating pace is the content to be overlaid and displayed.

The pace at which a user eats a meal is judged by the situation judging section 204 as described above. Further, whether the pace is fast or slow can be judged by comparing the current pace with a predetermined reference value.

### Example Overlay Display 6: Display after Meal

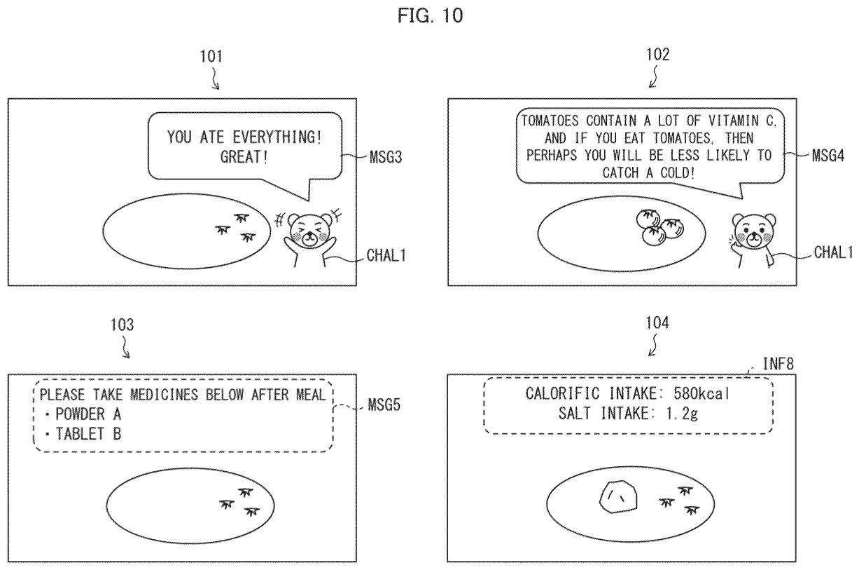

Overlay display performed after a meal will be described below on the basis of FIG. 10. FIG. 10 is a representation of examples of overlay display performed after a meal (to be exact, in a case where the situation judging section 204 judges that a meal is finished). Specifically, an image 101 illustrated in FIG. 10 is an example of the overlay display of the content performed in a case of a judgment that there are no leftovers after a meal. On the image 101, the character CHAL1 is overlaid and displayed on a portion lateral to the food, together with a message MSG3 from the character CHAL1. The message MSG3 is for congratulating a user on the absence of leftovers.

In a case where the situation judging section 204 judges that a meal is finished and that there are no leftovers, the determining section 206 may determine that content such as the message MSG3 for congratulating the user on the absence of leftovers is the content to be overlaid and displayed. As a matter of course, the judgment that a meal is finished and the judgment on the presence or absence of leftovers may be carried out separately in respective processing blocks.

By determining that content for congratulating a user on the absence of leftovers is the content to be overlaid and displayed and overlaying and displaying the content, it is possible to further increase the user's sense of accomplishment of the absence of leftovers. In addition, the presence of special content which is displayed on condition that there are no leftovers motivates a user to avoid resulting in leftovers.

An image 102 illustrated in FIG. 10 indicates an example overlay display of content performed in a case of a judgment that there are leftovers at the end of a meal. On the image 102, the character CHAL1 is overlaid and displayed on a portion lateral to the food, together with a message MSG4 from the character CHAL1. The message MSG4 is an explanation of an advantage of eating the ingredient left at the end of a meal.

In a case where the situation judging section 204 judges that a meal is finished and that there are leftovers, the determining section 206 determines that the above content is the content to be overlaid and displayed, so that it is possible to motivate a user to eat the ingredient left at the end of the meal. Further, as in this example, identifying the ingredient left at the end of a meal enables information in accordance with the food to be overlaid and displayed. This makes it possible to provide the user with a stronger motivation to eat the ingredient left at the end of the meal.

It is possible to judge the amount of leftovers and the ingredient left at the end of a meal by analyzing the image captured by the capturing section 22. Further, the determining section 206 may determine that content (e.g. a yearly amount of food loss and waste generated, the number of people suffering from food shortages, etc.) regarding problems of food loss and waste, which is the content serving as a motivation to prevent or reduce leftovers, is the content to be overlaid and displayed.

As above, the situation judging section 204 may judge the amount of leftovers of a user, and the determining section 206 may determine that content in accordance with the amount of leftovers judged is the content to be overlaid and displayed. This provides an example advantage of making it possible to, for example, encouraging a user to reduce leftovers, in addition to the example advantage provided by the information processing apparatus 1 in accordance with the first example embodiment. Note that, the judgment of the “amount of leftovers” includes a judgment of the presence or absence of leftovers (whether the amount of leftovers is zero).

In a case where the situation judging section 204 judges that a meal is finished, the determining section 206 may determine that content for asking a user about the presence or absence of an additional order or content for encouraging a user to place an additional order is the content to be overlaid and displayed. Further, in a case where an additional order is placed after the situation judging section 204 judges that a meal is finished, the determining section 206 may determine that special content intended to be displayed at the time of receiving an additional order is the content to be overlaid and displayed. This makes it possible to motivate a user to place an additional order.

For example, in a case where a user uses the information processing apparatus 2 when eating and drinking at a restaurant, the user may notify the restaurant of the meal situation judged by the situation judging section 204. For example, the information processing apparatus 2 may output the ingredient left by the user at the end of a meal or the amount of leftovers of the ingredient, to a terminal used by a person with the restaurant. In this outputting, a user attribute may be also outputted. These kinds of information constitute important reference information in considering cuisine or services provided by a restaurant. Further, the information processing apparatus 2 may output the user's pace of eating a meal and the user's degree of progress of the meal to the terminal. This makes it possible for the restaurant to provide services in accordance with the user's pace of eating a meal and the user's degree of progress of the meal.

An image 103 illustrated in FIG. 10 indicates another example of the overlay display of content performed after a meal. On the image 103, a message MSG5 for encouraging a user to take medicine, the message MSG5 containing a list of medicines to be taken, is overlaid and displayed. In a case of acquisition of the reference information which indicates that the user should take medicine, it is determined that such content is the content to be overlaid and displayed. A medicine to be taken, a timing of taking the medicine, etc. may be inputted by the user in advance to the information processing apparatus 2, or may be identified by making access to a server or the like, if any, which has recorded thereon the medicine to be taken, the timing of taking the medicine, etc. The similar identification method can be applied to another reference information.

As above, in a case where the reference information indicates that a user should take medicine, the determining section 206 may determine that content for encouraging the user to take medicine is the content to be overlaid and displayed. This provides an example advantage of enabling a user to remember to take medicine, in addition to the example advantage provided by the information processing apparatus 1 in accordance with the first example embodiment. Note that the overlay display of the content for encouraging a user to take medicine is not limited to being performed after a meal, but may be performed before and during the meal. In particular, the medicine is to be taken before a meal, the overlay display is desirably performed before a meal, and the medicine is to be taken after a meal, the overlay display is desirable performed after a meal.

An image 104 illustrated in FIG. 10 indicates still another example of the overlay display of content performed after a meal. On the image 103, information INF8 which indicates the calories and the amount of salt taken in by a user is overlaid and displayed. In a case of displaying calories, etc. after a meal as in this example, it is preferable to display a value calculated in consideration of an ingredient left at the end of the meal and the amount of leftovers. Note that as described above, it is possible to judge an ingredient left at the end of a meal and the amount of leftovers by analyzing the image captured by the capturing section 22.

### (Flow of Display Control Method: Before Start of Meal)

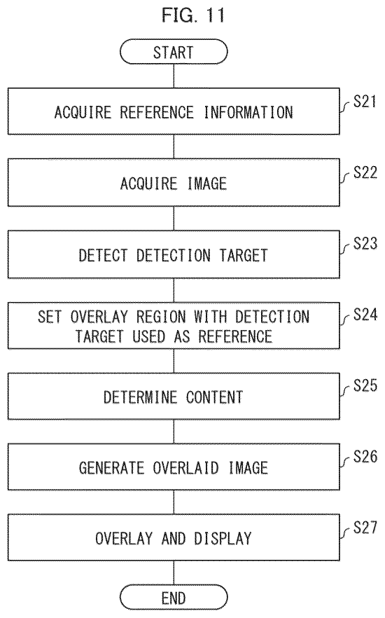

A flow of a display control method carried out by the information processing apparatus 2 will be described below with reference to FIG. 11. FIG. 11 is a flowchart illustrating a flow of the display control method. Note that described in the following description is an example in which before a user wearing the information processing apparatus 2 starts to have a meal, an image of predetermined food is overlaid and displayed on food disposed in front of the user.

In S21, the reference information acquiring section 205 acquires reference information. As described above, the reference information may be user-related information regarding the user, may be information indicating the situations of a current season, weather, etc., or may be information regarding food served to a user.

In S22, the image acquiring section 201 acquires an image captured by the capturing section 22, i.e. an image captured of at least part of the sight of the user wearing the information processing apparatus 2. This image has shown therein food the user is going to eat.

In S23, the detecting section 202 detects a predetermined detection target in the image acquired in S22. In S24, the overlay region setting section 203 then uses, as a reference, the detection target detected in S23, to set a content overlay region in the image acquired in S22. In a case of overlaying and displaying the image of the predetermined food on the food disposed in front of the user, the overlay region is set to be on the food disposed in front of the user.

In S25, the determining section 206 determines content to be overlaid and displayed on the image acquired in S22. More specifically, the determining section 206 determines content which is to be overlaid and displayed on the overlay region set in S24 and which is in accordance with the reference information acquired in S21. For example, in a case where the reference information acquired in S21 indicates that the user wishes to cut calorific intake, the determining section 206 may determine that an image of food containing higher calories than the food shown in the image acquired in S22 is the content to be overlaid and displayed.

In S26, the overlaid image generating section 207 generates an overlaid image of the content determined in S25. In a case of overlaying and displaying the image of a predetermined food, the overlaid image generating section 207 generates the overlaid image by processing a texture image of the predetermined food according to the shape and the size of the overlay region set in S24. Note that the generation of an overlaid image is not essential, but the content determined in S25 may be overlaid and displayed, as it is, on the image acquired in S22.

In S27, the display control section 208 overlays and displays the content determined in S25 on the image acquired in S22. Specifically, the display control section 208 displays the overlaid image generated in S26 such that the overlaid image is combined with the overlay region in the image acquired in S21. This causes the food disposed in front of the user wearing the information processing apparatus 2 to look like the predetermined food to the user. Note that the processes of FIG. 11 are carried out each time the image acquiring section 201 acquires a new image, and real-time overlay display is provided accordingly.

Although content is determined after an overlay region is set (i.e. after S24) in the flow of FIG. 11, the determination of content only needs to be carried out any timing at and after the point in time when pieces of information required to determine the content are acquired, and is not limited to this example. For example, provided that content to be determined is determined with use of the reference information acquired in S21, the content may be determined at any timing in and after S21.

Although the reference information is acquired in S21 in the beginning of the method in the flow of FIG. 11, also the timing of acquiring the reference information is not particularly limited. Further, in a case of acquiring a plurality of pieces of reference information, the pieces of reference information may be acquired at a time, or may be acquired at different timings. Assume, for example, that information indicating food ordered by a user is acquired as the reference information in S21. In this case, an ingredient which the user does not like and which is contained in the ordered food may be inputted by the user through, for example, an operation performed via the input section 24 or an operation based on a line of sight. The reference information acquiring section 205 may then acquire the inputted information as the reference information, and determine that the image of another ingredient replacing the ingredient the user does not like is the content to be overlaid and displayed.

### (Flow of Display Control Method: After Start of Meal)

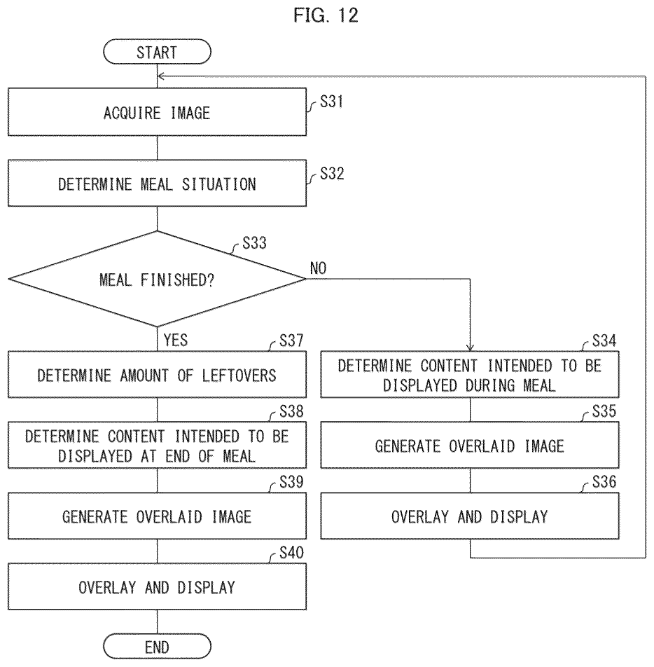

A flow of a display control method carried out by the information processing apparatus 2 after a user starts to have a meal will be described below with reference to FIG. 12. FIG. 12 is a flowchart illustrating a flow of a display control method carried out after the start of a meal. Note that since the process of S31 is the same as that of S21 of FIG. 11, the processes of S35 and S39 are the same as that of S26 of FIG. 11, and the process of S40 is the same as that of S27 of FIG. 11, the descriptions of these processes are not repeated.

In S32, the situation judging section 204 judges the meal situation of a user. As described above, various meal situations are expected as the meal situations judged by the situation judging section 204. Described in the following description is the example in which the situation judging section 204 judges the degree of progress of a meal (specifically, whether the meal is in progress or the meal is finished). Further, in a case of judging that a meal is in progress, the situation judging section 204 may make a judgment on an additional situation. For example, the situation judging section 204 may judge the degree of concentration of the user on the meal, the pace of eating a meal, etc.

In S33, the situation judging section 204 judges whether the user has finished the meal, on the basis of a result of the determination made in S32. In a case where the judgment is YES in S33, the method proceeds to the process of S37, and in a case where the judgment is NO in S33, the method proceeds to the process of S34.

In S34, the determining section 206 determines content to be overlaid and displayed on the image acquired in S31, the content being intended to be displayed during a meal. The content intended to be displayed during a meal is content in accordance with the situation where, for example, meal is in progress as illustrated in FIG. 9. Note that, in the determining in S34, the determining section 206 may determine content in accordance with the reference information acquired by the reference information acquiring section 205. Thereafter, an overlaid image of the content determined in S34 is generated in S35, and the overlay display of the content is performed in S36, and the method then returns to the process of S31.

In S37, the situation judging section 204 judges the amount of leftovers of a user. In S38, the determining section 206 then determines content to be overlaid and displayed on the image acquired in S31, the content being intended to be displayed at the end of a meal. The content intended to be displayed at the end of a meal is content in accordance with the situation where, for example, a meal is finished as illustrated in FIG. 10. Thereafter, an overlaid image of the content determined in S38 is generated in S39, and the overlay display of the content is performed in S40, and the processes of FIG. 12 ends. Note that the acquisition of an image and the overlay display may continue to be performed until the detection of an end operation performed by the user.

### (Utilization of Information Obtained by Using Information Processing Apparatus)

By a user using the information processing apparatus 2, various kinds of information are accumulated in the information processing apparatus 2. For example, by a user using the information processing apparatus 2, not only the reference information and the meal situations that are acquired for the determination of content are accumulated but line-of-sight information, order information, and any other information are also accumulated in the information processing apparatus 2.

Such kinds of information can be used in the determination of content at the time when the user uses the information processing apparatus 2 next time and subsequent times. As an example, the determining section 206 may identify, on the basis of the line-of-sight information, content which drew a high degree of attention from a user, and determine that the content or content related to the content is the content to be overlaid and displayed. As an example, the determining section 206 may determine that a character which is included in a plurality of characters previously overlaid and displayed by the information processing apparatus 2 and which drew attention from a user (i.e. which resulted in a relatively large amount of time during which the line of sight of the user is in the direction of that character) is the content to be overlaid and displayed. As another example, the determining section 206 may determine that a type of content which drew attention from a user (i.e. which resulted in a relatively large amount of time during which the line of sight of the user is in the direction of that character) when a plurality of types of content (e.g. a character and a background image) were displayed by the information processing apparatus 2 in the past is the content to be overlaid and displayed.

The pieces of information accumulated in the information processing apparatus 2 can be used not only in the determination of content but also in any other occasion. For example, the reference information acquired for the determination of content, the information indicating an ingredient left at the end of a meal, and the order information can be said to be preference information indicating the preference of a user on food. Such preference information can be used for recommendation on food and restaurant that match the preference of a user. For example, the information processing apparatus 2 may display an image and output voice at the time of order placement at restaurant, the image and the voice recommending food of the same genre as are the food which has not been left at the end of a meal so far and the food which has drawn attention from the user so far (i.e. which has resulted in a relatively large amount of time during which the line of sight of the user is in the direction of that character). Similarly, the information processing apparatus 2 may display an image and output voice at the time when a user select a restaurant, the image and the voice recommending a restaurant which serves food of the same genre as are the food which has not been left at the end of a meal so far and the food which has drawn attention from the user so far (i.e. which has resulted in a relatively large amount of time during which the line of sight of the user is in the direction of that character).

Further, it is possible to collect the pieces of information as described above from the information processing apparatus 2 (which may be at least one information processing apparatus 2) that has been used by various users, to use the pieces of information for various analyses. In a case of a use in the analyses, an individual user or restaurant is not required to be identified, and the pieces of information may be used as anonymized data. By using information collected in this manner, it is possible to infer the trend or tendency of a user in food. As an example, it is possible to infer a manner of selecting content which leads to a reduction in leftovers. As another example, it is possible to identify a restaurant or an area used at high frequency by a user of a predetermined user attribute. In such analyses, for example, heterogeneous mixture learning, rule discovery-based inference, and graph-based relational learning can be used.

The information processing apparatus 2 may be lent, in a restaurant or the like, to a customer of the restaurant, as a part of the service of the restaurant. Alternatively, the information processing apparatus 2 may be lent, as a part of the service in a hospital, a nursing home, etc. to a patient or a resident of the facility. In a case where a single information processing apparatus 2 is shared by a plurality of users, it is possible to display content in accordance with a user, by identifying the user at the beginning of use.

### [Variation]

A performer which carries out each of the processes described in the example embodiments above is any performer, and is not limited to the above examples. In other words, it is possible to construct a display control system having the same functions as those of the information processing apparatuses 1 and 2, with use of a plurality of apparatuses capable of mutual communication. For example, it is possible to construct a display control system having the same functions as those of the information processing apparatuses 1 and 2, by dispersedly providing, in a plurality of apparatuses, respective blocks illustrated in each of the block diagrams of FIGS. 1 and 4.

For example, among the blocks of the information processing apparatus 2 illustrated in FIG. 4, the blocks from the image acquiring section 201 to the overlaid image generating section 207 contained in the control section 20 may be provided in a server. In this case, the information processing apparatus 2 transmits to the server the image captured by the capturing section 22 and receives the image which has information overlaid thereon from the server to display the same. With such a display control system, it is possible to use a single server to cause the server to perform display control of a plurality of information processing apparatuses 2.

### [Software Implementation Example]

Some or all of the functions of each of the information processing apparatuses 1 and 2 may be implemented by hardware such as an integrated circuit (IC chip), or may be implemented by software.

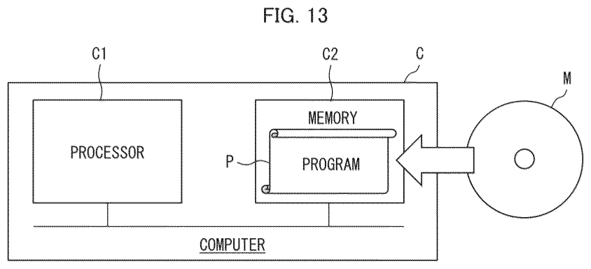

In the latter case, the information processing apparatuses 1 and 2 are provided by, for example, a computer that executes instructions of a program that is software implementing the foregoing functions. An example (hereinafter, computer C) of such a computer is illustrated in FIG. 13. The computer C includes at least one processor C1 and at least one memory C2. The memory C2 has recorded thereon a program (display control program) P for causing the computer C to operate as the information processing apparatus 1 or 2. The processor C1 of the computer C retrieves the program P from the memory C2 and executes the program P, so that the functions of the information processing apparatus 1 or 2 are implemented.

Examples of the at least one processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can also obtain the program P via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the above example embodiments.

### [Additional Remark 2]

The whole or part of the example embodiments disclosed above can be described as, but not limited to, the following supplementary notes.

### (Supplementary Note 1)

An information processing apparatus including: a determining means for determining content to be overlaid and displayed on an image captured of at least part of a sight of a user, the image having food shown therein; and a display control means for overlaying and displaying the content on the image.

### (Supplementary Note 2)

The information processing apparatus described in supplementary note 1, further including a situation judging means for judging a meal situation of the user, the determining means being configured to determine that content in accordance with the meal situation is the content to be overlaid and displayed.

### (Supplementary Note 3)

The information processing apparatus described in supplementary note 2, in which the situation judging means is configured to determine a degree of concentration which is a degree to which the user concentrates on eating a meal, and the determining means is configured to determine that content in accordance with the degree of concentration is the content to be overlaid and displayed.

### (Supplementary Note 4)

The information processing apparatus described in supplementary note 2, in which the situation judging means is configured to judge a degree of progress, which is a degree to which the user makes progress on eating a meal, and the determining means is configured to determine that content in accordance with the degree of progress is the content to be overlaid and displayed.

### (Supplementary Note 5)

The information processing apparatus described in supplementary note 2, in which the situation judging means is configured to judge an amount of leftovers of the user, and the determining means is configured to determine that content in accordance with the amount of leftovers is the content to be overlaid and displayed.

### (Supplementary Note 6)

The information processing apparatus described in supplementary note 2, in which the determining means is configured to use content prediction model having undergone machine learning of a relationship between the meal situation and content to be displayed in the meal situation, to determine the content in accordance with the meal situation judged by the situation judging means.

### (Supplementary Note 7)

The information processing apparatus described in any one of supplementary notes 1 to 6, in which the determining means is configured to determine that an image of predetermined food is the content to be overlaid and displayed, and the display control means is configured to overlay and display the image of the predetermined food on the food shown in the image captured of the at least part of the sight of the user.

### (Supplementary Note 8)

The information processing apparatus described in supplementary note 7, in which the predetermined food is the same as the food shown in the image except for an amount.

### (Supplementary Note 9)

The information processing apparatus described in any one of supplementary notes 1 to 8, further including a reference information acquiring means for acquiring reference information referred to during determination of the content, the determining means being configured to determine that content in accordance with the reference information is the content to be overlaid and displayed.

### (Supplementary Note 10)

The information processing apparatus described in supplementary note 9, in which in a case where the reference information indicates that the user is a user who wishes to cut calorific intake, the determining means is configured to determine that an image of food which contains higher calories than the food shown in the image is the content to be overlaid and displayed, and the display control means is configured to overlay and display, on the food shown in the image captured of the at least part of the sight of the user, the image determined by the determining means.

### (Supplementary Note 11)

The information processing apparatus described in supplementary note 9 or 10, in which in a case where the reference information indicates that a preference of the user, the determining means is configured to determine that an image of food which matches the preference is the content to be overlaid and displayed, and the display control means is configured to overlay and display, on the food shown in the image captured of the at least part of the sight of the user, the image determined by the determining means.

### (Supplementary Note 12)

The information processing apparatus described in any one of supplementary notes 9 to 11, in which in a case where the reference information indicates that the user needs to take medicine, the determining means is configured to determine that content for encouraging the user to take medicine is the content to be overlaid and displayed.

### (Supplementary Note 13)

The information processing apparatus described in any one of supplementary notes 9 to 12, in which in a case where the reference information indicates a result of identification of the food shown in the image, the determining means is configured to determine that a background image in accordance with the result of identification is the content to be overlaid and displayed, and the display control means is configured to overlay and display the background image on a background of the food shown in the image captured of the at least part of the sight of the user.

### (Supplementary Note 14)

The information processing apparatus described in any one of supplementary notes 1 to 13, in which the determining means is configured to determine that an image of a person or a character is the content to be overlaid and displayed, and the display control means is configured to overlay and display the image of the person or the character on the image captured of the at least part of the sight of the user.

### (Supplementary Note 15)

The information processing apparatus described in any one of supplementary notes 1 to 14, in which the determining means is configured to determine that an image of a container or a dish which is different in size from a container or a dish which holds the food is the content to be overlaid and displayed, and the display control means is configured to overlay and display the image of the container or the dish on a background of the food shown in the image captured of the at least part of the sight of the user.

### (Supplementary Note 16)

A display control method including: at least one processor determining content to be overlaid and displayed on an image captured of at least part of a sight of a user, the image having food shown therein; and the at least one processor overlaying and displaying the content on the image.

### (Supplementary Note 17)

A display control program for causing a computer to function as a determining means for determining content to be overlaid and displayed on an image captured of at least part of a sight of a user, the image having food shown therein; and a display control means for overlaying and displaying the content on the image.

### [Additional Remark 3]

The whole or part of the example embodiments disclosed above can be described as follows. An information processing apparatus including at least one processor, the at least one processor carrying out: a process of determining content to be overlaid and displayed on an image captured of at least part of a sight of a user, the image having food shown therein; and a process of overlaying and displaying the content on the image.

This information processing apparatus may further include a memory, and the memory may have stored therein a display control program for causing the at least one processor to carry out: a process of determining content to be overlaid and displayed on an image captured of at least part of a sight of a user, the image having food shown therein; and a process of overlaying and displaying the content on the image. A computer-readable non-transitory tangible recording medium may have this display control program recorded thereon.

### REFERENCE SIGNS LIST

1, 2: Information processing apparatus
11, 206: Determining section
12, 208: Display control section
204: Situation judging section
205: Reference information acquiring section

What is claimed is:

1. An information processing apparatus comprising at least one processor, the at least one processor carrying out:
a determining process of determining content to be overlaid and displayed on an image captured of at least part of a sight of a user, the image having food shown therein; and
a display control process of overlaying and displaying the content on the image.

2. The information processing apparatus according to claim 1, the at least one processor further carries out
a situation judging process of judging a meal situation of the user,
the determining process being configured to determine that content in accordance with the meal situation is the content to be overlaid and displayed.

3. The information processing apparatus according to claim 2, wherein
the situation judging process is configured to determine a degree of concentration which is a degree to which the user concentrates on eating a meal, and
the determining process is configured to determine that content in accordance with the degree of concentration is the content to be overlaid and displayed.

4. The information processing apparatus according to claim 2, wherein
the situation judging process is configured to judge a degree of progress, which is a degree to which the user makes progress on eating a meal, and
the determining process is configured to determine that content in accordance with the degree of progress is the content to be overlaid and displayed.

5. The information processing apparatus according to claim 2, wherein
the situation judging process is configured to judge an amount of leftovers of the user, and
the determining process is configured to determine that content in accordance with the amount of leftovers is the content to be overlaid and displayed.

6. The information processing apparatus according to claim 2, wherein
the determining process is configured to use content prediction model having undergone machine learning of a relationship between the meal situation and content to be displayed in the meal situation, to determine the content in accordance with the meal situation judged by the situation judging process.

7. The information processing apparatus according to claim 1, wherein
the determining process is configured to determine that an image of predetermined food is the content to be overlaid and displayed, and
the display control process is configured to overlay and display the image of the predetermined food on the food shown in the image captured of the at least part of the sight of the user.

8. The information processing apparatus according to claim 7, wherein
the predetermined food is the same as the food shown in the image except for an amount.

9. The information processing apparatus according to claim 1, the at least one processor further carries out
a reference information acquiring process of acquiring reference information referred to during determination of the content,
the determining process being configured to determine that content in accordance with the reference information is the content to be overlaid and displayed.

10. The information processing apparatus according to claim 9, wherein
in a case where the reference information indicates that the user is a user who wishes to cut calorific intake, the determining process is configured to determine that an image of food which contains higher calories than the food shown in the image is the content to be overlaid and displayed, and
the display control process is configured to overlay and display, on the food shown in the image captured of the at least part of the sight of the user, the image determined by the determining process.

11. The information processing apparatus according to claim 9, wherein
in a case where the reference information indicates that a preference of the user, the determining process is configured to determine that an image of food which matches the preference is the content to be overlaid and displayed, and
the display control process is configured to overlay and display, on the food shown in the image captured of the at least part of the sight of the user, the image determined by the determining process.

12. The information processing apparatus according to claim 9, wherein
in a case where the reference information indicates that the user needs to take medicine, the determining process is configured to determine that content for encouraging the user to take medicine is the content to be overlaid and displayed.

13. The information processing apparatus according to claim 9, wherein
in a case where the reference information indicates a result of identification of the food shown in the image, the determining process is configured to determine that a background image in accordance with the result of identification is the content to be overlaid and displayed, and
the display control process is configured to overlay and display the background image on a background of the food shown in the image captured of the at least part of the sight of the user.

14. The information processing apparatus according to claim 1, wherein
the determining process is configured to determine that an image of a person or a character is the content to be overlaid and displayed, and
the display control process is configured to overlay and display the image of the person or the character on the image captured of the at least part of the sight of the user.

15. The information processing apparatus according to claim 1, wherein
the determining process is configured to determine that an image of a container or a dish which is different in size from a container or a dish which holds the food is the content to be overlaid and displayed, and
the display control process is configured to overlay and display the image of the container or the dish on a background of the food shown in the image captured of the at least part of the sight of the user.

16. A display control method comprising:
at least one processor determining content to be overlaid and displayed on an image captured of at least part of a sight of a user, the image having food shown therein; and
the at least one processor overlaying and displaying the content on the image.

17. A non-transitory storage medium storing a display control program for causing a computer to carry out
a determining process of determining content to be overlaid and displayed on an image captured of at least part of a sight of a user, the image having food shown therein; and
a display control process of overlaying and displaying the content on the image.
